(19) United States
(12) Patent Application Publication
(10) Pub. No.: US 2015/0241266 A1
(43) Pub. Date: Aug. 27, 2015

(54) WEIGHING APPARATUS AND METHOD FOR OPERATING THE WEIGHING APPARATUS

(71) Applicant: MULTIPOND Wägetechnik GmbH, Waldkraiburg (DE)

(72) Inventors: Klaus RIEFLE-WEBER, Waldkraibury (DE); Andreas PETERS, Aschau am Inn (DE); Wolfram C. ZECK, Muhldorf (DE)

(73) Assignee: MULTIPOND Wägetechnik GmbH, Waldkraiburg (DE)

(21) Appl. No.: 14/627,292

(22) Filed: Feb. 20, 2015

(30) Foreign Application Priority Data
Feb. 21, 2014 (EP) 14 156 187.8

(51) Int. Cl. G01G 7/02; G01G 23/10

(52) U.S. Cl. CPC G01G 7/02; G01G 23/10

(57) ABSTRACT

An assembly of a load cell with an armature joined thereto and an electromagnet. The electromagnet and the armature are separately fixed and they are arranged such that a magnet force which is opposite to a deflection during a weighing procedure and which reduces a deflection caused by an impact momentum of an object to be weighed is exerted to the load cell when the electromagnet is activated.

### BACKGROUND OF THE INVENTION

1. Field of the Invention

The invention relates to a weighing apparatus and a method for operating the weighing apparatus, in particular, a weighing apparatus and a method for weighing objects falling onto the weighing apparatus.

2. Discussion of the Related Art

When objects, e.g. being bulk goods, fall onto a load cell or into a container joined to the load cell, an impact momentum accrues.

By this impact momentum, impact energy is transmitted to the load cell. Compared to a deflection by the static weight of the objects, this impact energy can deflect the load cell about a multiple thereof. Thereby, the load cell may be damaged or the precision thereof may be reduced.

Furthermore, the impact energy transmitted to the load cell must be dissipated. Thereby, the load cell is vibrated according to its natural frequency and the impact energy is e.g. transformed into heat by inner friction. However, since no constant measuring signal of the load cell indicating the weight of the objects on the load cell or in the container is possible due to the vibrations, detecting the actual weight of the objects takes much more time than in the case of an object which is laid on the load cell or into the container.

As a corrective action against the excessive deformation and the vibration, mechanical elements, e.g. stoppers or dampers having a pneumatic principle of operation, with oil or as an elastomer or as a wire cushion are used, which however is lavish and requests enlarged installation space. Further options are additional filtering of the signals by means of analog filters or digital filters in order to eliminate high frequency vibration, which however does not filter out low frequency vibrations so that the time for detecting the actual weight is not reduced.

### SUMMARY OF THE INVENTION

It is the object of the invention to remove the above disadvantages and to provide a simple economic solution, having low height which can also be retrofitted, for reducing the deflection of the load cell due to the impact momentum as well as for vibration damping.

The object is achieved by an assembly having a load cell and an electromagnet having an armature, wherein the armature is fixed to the load cell, the electromagnet is separately fixed, and the electromagnet and the armature are arranged such that when actuating the electromagnet, a magnetic force is applied to the load cell, the force being opposite to a deflection during a weighing process and reducing a deflection caused by an impact momentum of an object to be weighed. The object is also achieved by weighing apparatus having the features an assembly described previously, and a control device connected to the load cell and to the electromagnet (3) and adapted to control the electromagnet.

Moreover, an electromagnet can be controlled such that, controlled by a control device, the stiffness of the load cell can be adjusted such that the vibrations of the load cell can be damped in a fast and effective manner.

### BRIEF DESCRIPTION OF THE DRAWINGS

Now, the invention is elucidated by means of embodiments referring to the attached drawings.

In particular,

FIG. 1 shows an assembly of a load cell with an armature joined thereto and a separately fixed electromagnet;

FIG. 2 shows a diagram with a transient signal;

FIG. 3 shows a diagram with a magnetic counter pulse;

FIG. 4 shows a diagram with a transient signal superimposed by a magnetic counter pulse; and

FIG. 5 shows a diagram with a behavior of a vibration damping.

### DETAILED DESCRIPTION OF THE DRAWINGS

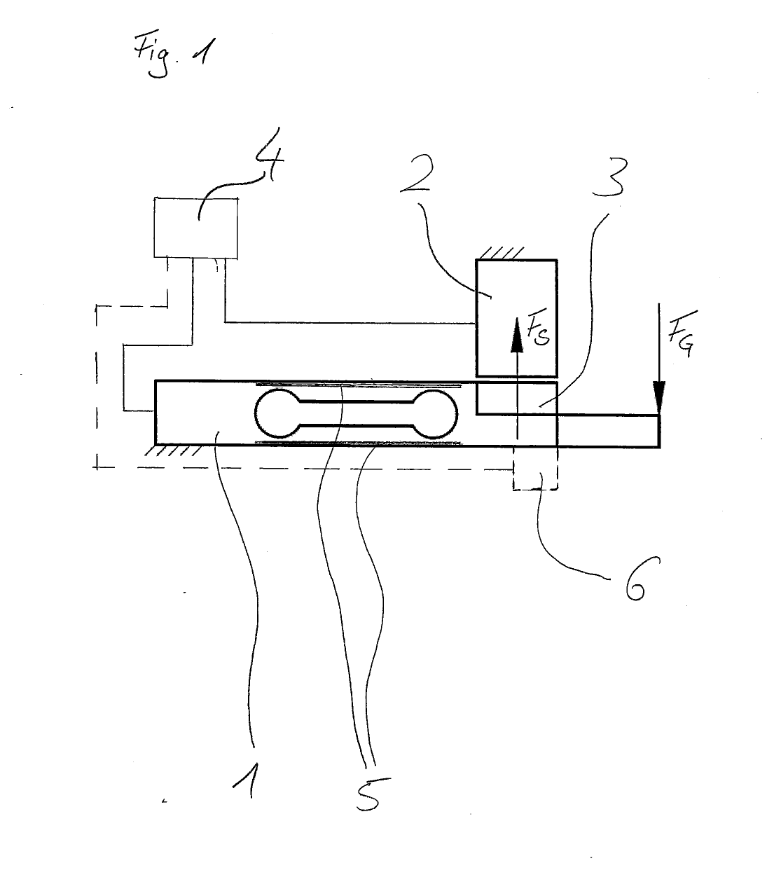

FIG. 1 shows an assembly, consisting of a load cell 1 and an electromagnet 2, incorporated into a combination scale. The load cell 1 and the electromagnet 2 are separately fixed to a symbolically shown housing of a weighing apparatus. For collaborating with the electromagnet 2, the assembly comprises an armature 3 integrated into the load cell 1. Alternatively, the armature 3 is not integrated in the load cell 1 but it is joined thereto in another manner, e.g. put onto.

The electromagnet 2 is optionally provided with a pot-core coil or a moving coil.

When loading the load cell 1 with an object to be weighed, optionally via a container fixed to the load cell 1 for accommodating the objects to be weighed, a force F_{G} is exerted. In case when the load is static, the force F_{G} corresponds to the weight force of the objects to be weighed. In case of a dynamic load, e.g. when the objects to be weighed impact onto the load cell 1, the force F_{G} corresponds to an impact momentum.

By the collaboration of the electromagnet 2 and the armature 3, a force F_{S} acts between the electromagnet 2 and the armature 3 as soon as the electromagnet 2 is activated. By the force F_{S}, the force F_{S} acts upwardly onto the end of the load cell illustrated right in FIG. 1, i.e. opposite to the weight force F_{G} downwardly directed in FIG. 1, and, therefore, it acts as a counterforce or magnetic counter pulse.

As well, the stiffness of a body is defined as a resistance against elastic deformation caused by the force F_{G}. When exerting the force F_{G} onto the load cell 1, the load cell deforms about a particular amount depending on its inherent stiffness. When now a counterforce F_{S} opposite to the force F_{G} is additionally exerted, the stiffness of the load cell 1 is increased and the load cell is not any more deflected so much. An increase of the stiffness of the load cell consequently reduces the effect of a force F_{G} acting onto the load cell 1.

Optionally, the electromagnet 2 is arranged in a predetermined distance of e.g. about 0.3 mm so that the electromagnet 2 can serve as a stopper for the armature 3 when the load cell 1 is excessively deformed.

The load cell 1 is here provided with strain gauges 5 in order to detect a force F_{G} by means of a deformation of the elastic body of the load cell 1. Optionally, the deformation can also be detected by other means, as e.g. optical means or inductive means.

Further, a control device 4 is provided in the assembly and it is connected to the load cell 1 in order to detect measuring signals output by the load cell 1. The control device 4 is also connected to the electromagnet 2 and it controls the electromagnet 2.

The control device 4 is adapted to evaluate the detected signal of the load cell 1. The measuring signal of the load cell 1 indicates whether the load cell 1 deforms, i.e. whether it is deflected, and, thus, in conjunction with the stiffness of the load cell 1, it indicates a force acting onto the load cell 1. Without the force F_{G} created by the electromagnet 2, in a stationary state of the deflection of the load cell 1, i.e. with a constant measuring signal, the measuring signal indicates the force F_{G} as being the weight force of the objects to be weighed. When the signal alters, the measuring signal indicates that an object exerts an impact momentum onto the load cell 1 or that the deflection of the load cell 1 oscillates.

Subsequently, an effect of a superposition of the impact momentum and the magnetic counter pulse is elucidated.

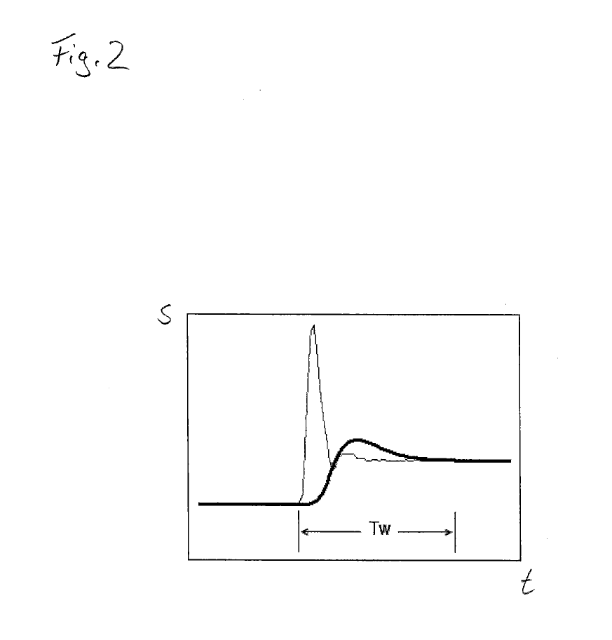

In FIG. 2, a diagram with a transient signal is shown. The diagram shows a time t on the horizontal axis and the measuring signals corresponding to the deflection of the load cell 1 on a vertical axis. Thereby, a thin line shows a measuring signal with unfiltered ADC values of the load cell during an impact momentum where a fast increase with a large overshoot exists with the unfiltered values. A thick line shows a filtered measuring signal. It can be seen that the filtered measuring signal is delayed and that it indicates a smaller deflection. The period for levelling off at a static end value is indicated by Tw. The measuring signals result for a load cell 1 which is either not provided with an armature 3 or the electromagnet 2 thereon is not activated.

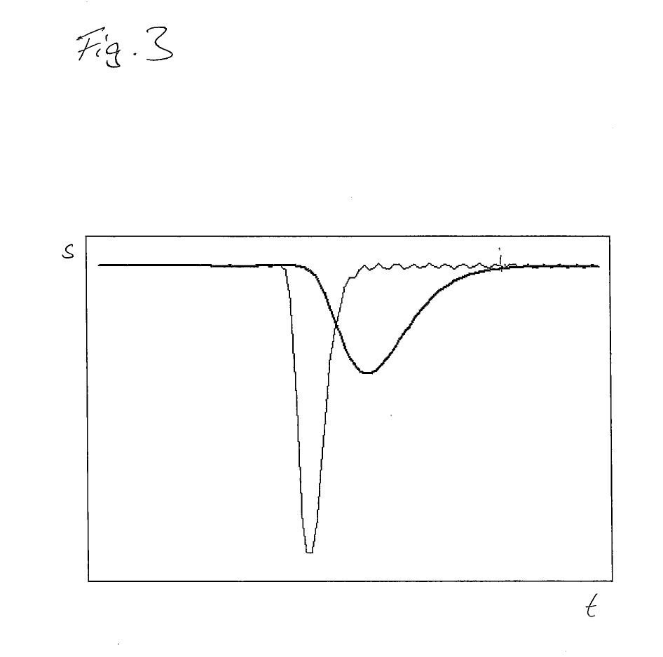

In FIG. 3, a diagram with a magnetic counter pulse which is generated by the electromagnet 2 controlled by the control device 4. The diagram shows the time t on the horizontal axis and the measuring signals corresponding to the magnitude of the deflection s of the load cell 1 due to the counter pulse of the magnet on the vertical axis. Hereby, a thin line shows an unfiltered measuring value of the deflection s caused by the magnetic counter pulse and a thick line shows the filtered measuring signal of the deflections due to the magnetic counter pulse.

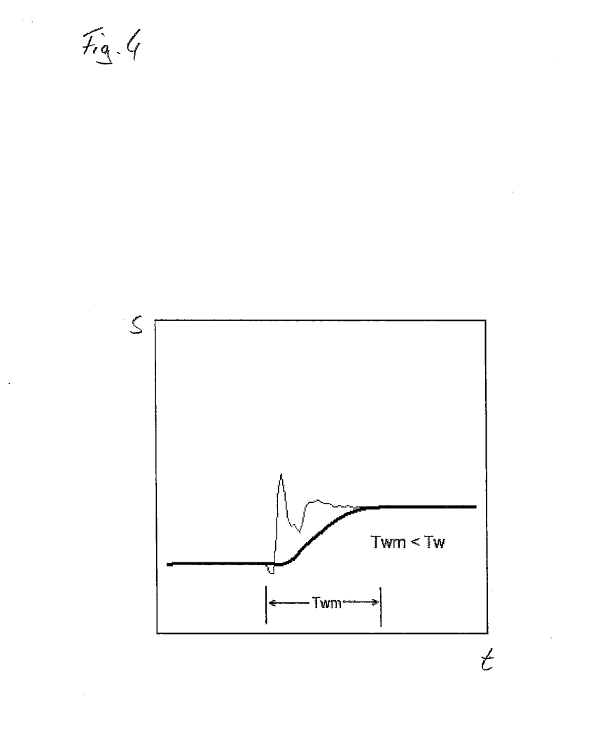

In FIG. 4, a diagram with the transient signal superimposed by the magnetic counter pulse is shown. The thin line shows a graph of the measuring signal with unfiltered ADC values of the load cell 1 due to the impact momentum illustrated as thin line in FIG. 2 which is superimposed by the measuring value of the load cell 1 due to the magnetic counter pulse illustrated as thin line in FIG. 3. Also here, the thin line shows the unfiltered measuring signal. Compared to the behavior of the unfiltered measuring signal due to the impact momentum shown in FIG. 2, it can be recognized that, here, the overshoot is considerably smaller and, therefore, the load cell 1 is considerably less deflected. Contrary to the thick line in FIG. 2, the thick line showing the filtered measuring signal does not have any overshoot anymore and it indicates earlier a static end value, whereby a period Twm until the levelling off to the static end value is smaller than the period Tw in the case shown in FIG. 2.

In one embodiment, the control device 4 shown in FIG. 1 is designed such that, besides the detection of the measuring signal of the load cell 1 and the control of the electromagnet 2, an operation flow of an entire scale (not shown) is controlled. Hereby, amongst others, triggering of falling off of objects to be weighed, i.e. a start of the falling off onto the load cell 1 or into the container, is controlled and a trigger signal for the start of the falling off of an object to be weighed is created.

In an alternative embodiment, the scale is provided with a separate overall control device which is then connected to the control device 4 and which also supplies the trigger signal for the start of the falling off of an object to be weighed to the control device 4, whereby the control device 4 then detects this trigger signal.

In these two embodiments in which the trigger signal for the start of the falling off of the objects to be weighed is created or detected, the control device 4 is designed to control the electromagnet 2 such that a magnetic counter pulse with the force F_{S} onto the load cell 1 is created depending on the trigger signal of the start of the falling off of the objects to be weighed. Thereby, the stiffness of the load cell 1 is increased and the load cell 1 is effectively pre-stressed before the objects to be weighed fall onto the load cell. Thus, during impact of the objects to be weighed, the deflection of the load cell 1 can be smaller and a deflection beyond a predetermined limit determined in advance can e.g. be prevented thereby.

In a further alternative embodiment, the load cell 1 is not pre-stressed before the impact of the objects to be weighed, but by a delayed control of the counter pulse, an excessive deflection accompanied by the risk of damage is prevented or reduced as recently as during the impact momentum, whereby the vibration of the load cell is also directly suppressed.

The impact momentum onto the load cell 1 is detected by the load cell 1 and a corresponding signal is transmitted to the control device 4. The control device 4 is here adapted to control the electromagnet 2 depending on the measuring signal resulting due to impact momentum received by the load cell 1.

Since the magnetic counter pulse shall be created directly after the impact of the objects to be weighed in order to prevent a large deflection of the load cell 1, the filtered signal shown in FIG. 2 is not suitable as a basis for the control of the electromagnet 2 for an increase of the stiffness of the load cell 1. Due to this reason, in this case, the unfiltered signal is used for the control of the electromagnet 2 in order to directly start the magnetic counter pulse.

Optionally, the weighing apparatus comprises a separate sensor 6 detecting the deflection, therefore also a start of the deflection, of the load cell 1. The sensor 6 is designed as an acceleration sensor or a position sensor. Alternatively, the electromagnet 2 with an inductivity measuring device can also serve as a position sensor. Upon a deflection of the load cell 1, a residual air gap of the electromagnet 2 increases, which then results in a decrease of the measured inductivity. Thereby, a position of the armature 3 and, thus, the deflection of the load cell 1 can be detected.

The sensor 6 is also connected to the control device 4. A signal of the sensor 6 is evaluated by the control device 4, whereby the start of the deflection of the load cell 1 as well as the behavior of the deflection can be determined.

An output signal of the control device 4 created for controlling the electromagnet depends on the parameters “point in time of the force momentum” (starting-time) and “period of the force momentum” (actuating period). The “point in time of the force momentum” is determined by the point in time of the start of the free fall of the objects, the height of fall and the local gravity. The “period of the force momentum” (actuating period) depends on the magnitude of the impact momentum which in turn depends on the mass, the height of fall, the local gravity and characteristics of the product.

In all of the embodiments, the control device 4 is provided with means for calculating and/or determining the different respectively necessary parameters.

The control device 4 is further optionally designed to reduce vibrations of the load cell 1. The vibrations can be a not-damped or a not completely damped vibration due to the impact momentum or they can be initiated by an external jamming source. These jamming sources can be e.g. mechanical oscillations of the underground due to motors, conveying systems or the like, or electrical influences by power line frequencies or frequency-controlled drives. However, thereby emerging low-frequency vibrations cannot be reliably suppressed by low-pass filters of measuring arrangements. With an appropriate high data rate, the control device 4 can exactly determine extreme values of theses vibrations and, under consideration of the phase shifting, output magnetic counter pulses reducing the deflection of the load cell 1 by means of the electro magnet 2. Thereby, the parameters (starting-time, actuating period) are respectively newly calculated depending on the actual state of the load cell 1.

In operation, different methods in order to realize a reduction of the deflection of the load cell 1 due to the impact momentum as well as a damping of vibration are possible.

In the methods in which the load cell 1 is pre-stressed before the impact momentum or during the impact momentum of the object to be weighed, the trigger signal for the start of the falling off of the body to be weighed is firstly output or optionally detected by the control device 4 or optionally by the overall control device. Therefore, the control device 4 knows itself the time of the start of the free fall or it optionally detects the start of time from the overall control device. At a predetermined point in time (starting-time), a pulsed output signal is given to the electromagnet 2 for a predetermined period (actuating period) by the control device in order to increase the stiffness of the load cell 1.

The starting-time is determined depending on the height of fall and the local gravity. At the starting-time the electromagnet 2 is controlled by the control device 4 such that the magnetic counter pulse pre-stesses the load cell 1, whereby it has a larger stiffness than without the magnetic counter pulse before or during the object to be weighed exerts the impact momentum onto the load cell 1. The period of the magnetic counter pulse is determined depending on the magnitude of the impact momentum resulting from the mass, the height of fall and product characteristics of the object to be weight and on the local gravity.

Compared to FIG. 2, as shown in FIG. 4, in this method, the load cell is not deflected as much during the impact momentum of the objects to be measured onto the load cell 1 or the container joined thereto due to the counter pulse. In the measuring signal, no overshoot emerge and the period until a constant measuring signal exists is shorter.

In an alternative method in which the point in time of the start of the free fall of the object to be weighed is not considered for reducing the deflection of the load cell due to the impact momentum, the measuring signal of the load cell 1 due to the impact momentum is detected before the output of the pulsed output signal by the control device 4. From an analysis of the measuring signal, the magnitude of the impact momentum is determined by the control device 4, the parameter of the period of the force momentum is determined and an appropriate output signal as a single pulse signal for the counter pulse is immediately output to the electromagnet 2.

As a result of the impact momentum of the objects to be measured onto the load cell 1 or the container joined thereto, also in this method, the load cell is not deflected as much and also overshoots in the measuring signal and the period until a constant measuring signal exists are reduced.

In a further alternative method, the measuring signal of the load cell 1 is not detected but the signal of the sensor 6 detecting the deflection of the load cell 1 is detected. Apart from that, the method corresponds to the aforementioned.

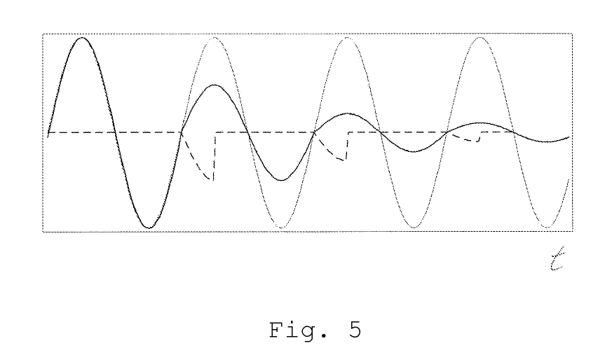

Moreover, in order to reduce the period until a constant measuring signal exists, in one method, periodic pulses during vibration of the load cell 1 are detected also after a decay of the impact momentum of an object to be weighed. As shown in FIG. 5, a periodical pulse opposite in phase is given to the load cell 1 always at a zero-crossing of the vibration, shown by a thick line, i.e. at periodic pulses respectively in the identical phase by the electromagnet 2. By each of these counter pulses, the amplitude of the vibration is then reduced so that, compared to the not-damped vibration shown by the thin line, the period until a constant measuring signal exists is reduced.

The parameters of the periodic pulses are either determined in advance or optionally calculated at each received impulse.

The parameters of a set of parameters are optionally varied within a predetermined probability range, namely a predetermined value range, and a respective output signal is given to the electromagnet 2. The effect of the several sets of parameters to the current measuring signal is detected and the output signal with the parameters of the set of parameters having the effect that the vibrations are damped in an enhanced manner so that a constant measuring signal is output as quickly as possible is output to the electromagnet 4. Thus, parameters optimal for specific criteria are determined in order to achieve an adaptive assimilation to altered conditions, whereby the weighing apparatus is self-learning in order to optimally damp the vibration of the load cell 1.

In order to permanently ensure the operation of the electromagnet 2 upon the respective output signals, a remanence of the electromagnet is erased by directed commutating.

The various embodiments can be combined.

What is claimed is:

1. A weighing assembly for weighing an object, the assembly comprising:
a load cell experiencing a weight deflection, the weight deflection comprising a first deflection during weighing of the object and a second deflection caused by an impact momentum of the object during weighing of the object, and
an electromagnet comprising an armature, the armature fixed to the load cell, the electromagnet not being fixed to the load cell;
wherein the electromagnet and the armature are arranged such that when actuating the electromagnet a magnetic force is applied to the load cell, the magnetic force being opposite to the first deflection and reducing the second deflection.

2. A weighing apparatus for weighing an object, the weighing apparatus comprising:
a weighing assembly comprising
a load cell experiencing a weight deflection, the weight deflection comprising a first deflection during weighing of the object and a second deflection caused by an impact momentum of the object during weighing of the object, and
an electromagnet comprising an armature,
the armature fixed to the load cell,
the electromagnet not being fixed to the load cell, the electromagnet and the armature are arranged such that when actuating the electromagnet a magnetic force is applied to the load cell,
the magnetic force being opposite to the first deflection and reducing the second deflection; and
a control device connected to the load cell and to the electromagnet and adapted to control the electromagnet.

3. The weighing apparatus according to claim 2, wherein the electromagnet is arranged in such a distance from the armature that the electromagnet is provided as a stopper for the armature.

4. The weighing apparatus according to claim 2, wherein the control device controls the electromagnet according to a signal of a start of a falling off and of a height of falling of the object being weighed.

5. The weighing apparatus according to claim 2, further comprising a sensor for detecting the weight deflection of the load cell.

6. The weighing apparatus according to claim 5, wherein the control device controls the electromagnet according to weight deflection of the load cell detected by the sensor.

7. The weighing apparatus according to claim 2, wherein the control device controls the electromagnet according to a measuring signal received from the load cell.

8. The weighing apparatus according to claim 2, wherein the control device is configured for determining parameters, at least an actuating period of the electromagnet, or a starting-time of an actuation of the electromagnet.

9. A method for operating a weighing apparatus,
the weighing apparatus comprising
a weighing assembly comprising
a load cell experiencing a weight deflection, the weight deflection comprising a first deflection during weighing of the object and a second deflection caused by an impact momentum of the object during weighing of the object, and
an electromagnet comprising an armature, the armature fixed to the load cell, the electromagnet not being fixed to the load cell, the electromagnet and the armature are arranged such that when actuating the electromagnet a magnetic force is applied to the load cell, the magnetic force being opposite to the first deflection and reducing the second deflection;
a control device connected to the load cell and to the electromagnet and adapted to control the electromagnet;
the method comprising the step of
(a) outputting a pulsed output signal of a predetermined period at a predetermined time to the electromagnet.

10. The method of claim 9, further comprising
prior to step (a) the step of
detecting the signal of the start of the falling off of the object to be weighed by the control device; and
performing step (a) as the step of
outputting the pulsed output signal before an impact momentum or during an impact momentum of the object being weighed on the load cell.

11. The method according to claim 9, further comprising
prior to step (a) the step of
detecting a measuring signal of the load cell by the control device; and
performing step (a) as the step of
outputting the pulsed output signal based on the measuring signal detected in the prior step.

12. The method according to claim 11, comprising the step of
during fluctuations of the measuring signal, reducing by the control device the fluctuations of the measuring signal by magnetic pulses in opposition and also after attenuation of an impact momentum.

13. The method according to claim 12;
wherein the control device is configured for determining parameters, at least an actuating period of the electromagnet, or a starting-time of an actuation of the electromagnet;
the method further comprising the step of
varying the parameters of a set of parameters within a predetermined range of values,
detecting the effects on the measuring signal;
determining the parameters optimal for specific criteria to achieve an adaptive assimilation to altered conditions.

14. The method of claim 9; further comprising the step of
erasing a remanence of the electromagnet by directed commutating.

15. A combination scale comprising:
a weighing apparatus comprising
a weighing assembly comprising
a load cell experiencing a weight deflection, the weight deflection comprising a first deflection during weighing of the object and a second deflection caused by an impact momentum of the object during weighing of the object, and
an electromagnet comprising an armature,
the armature fixed to the load cell,
the electromagnet not being fixed to the load cell, the electromagnet and the armature are arranged such that when actuating the electromagnet a magnetic force is applied to the load cell,
the magnetic force being opposite to the first deflection and reducing the second deflection; and
a control device connected to the load cell and to the electromagnet and adapted to control the electromagnet.

16. The combination scale according to claim 15, wherein the electromagnet is arranged in such a distance from the armature that the electromagnet is provided as a stopper for the armature.

17. The combination scale according to claim 15, wherein the control device controls the electromagnet according to a signal of a start of a falling off and of a height of falling of the object being weighed.

18. The combination scale according to claim 15, further comprising a sensor for detecting the weight deflection of the load cell.

19. The combination scale according to claim 18, wherein the control device controls the electromagnet according to weight deflection of the load cell detected by the sensor.

20. The combination scale according to claim 15, wherein the control device controls the electromagnet according to a measuring signal received from the load cell.

21. The combination scale according to claim 15, wherein the control device is configured for determining parameters, at least an actuating period of the electromagnet, or a starting-time of an actuation of the electromagnet.
